(19) United States
(12) Patent Application Publication
(10) Pub. No.: US 2024/0103468 A1
(43) Pub. Date: Mar. 28, 2024

(54) METHOD OF OPERATING A MACHINE SYSTEM AND MACHINE SYSTEM

(71) Applicant: United Grinding Group AG, Bern (DE)

(72) Inventors: Christoph Plüss, Burgdorf (CH); Urs Diergardt, Bern (CH); Christian Josi, Steffisburg (CH); Marcus Köhnlein, Rumlang (CH)

(21) Appl. No.: 18/265,073

(22) PCT Filed: Oct. 21, 2021
(86) PCT No.: PCT/EP2021/078090

§ 371 Date: Jun. 2, 2023

(30) Foreign Application Priority Data
Dec. 4, 2020 (EP) 20211986.3

(51) Int. Cl. G05B 19/02

(52) U.S. Cl. CPC G05B 19/02

(57) ABSTRACT

The invention relates to a method of operating a machine system (1) comprising a plurality of machines (2). Said machines (2) are in particular machine tool devices with numerical control, NC, or programmable logic controller, PLC, control systems and are connected to a computing system (3) of the machine system (1). The machine system (1) further comprises human-machine-interfaces (8; 9; 10; 11) to present machine (2) information and at least one operator detection unit (6; 7). Said operator detection unit (6; 7) detects a machine operator (4) being in the proximity of a machine (2) and/or walking past a machine (2) and collects operator behavior data (5). The operator detection unit (6; 7) sends the collected operator behavior data (5) to the computing system (3) which selects information to be presented to the machine operator (4) in dependence on the operator behavior data (5) and selects at least one of the human-machine-interfaces (8; 9; 10; 11) to present said information. Finally, the respective human-machine-interfaces (8; 9; 10; 11) present the selected information.

### FIELD OF THE INVENTION

This The invention relates to a method of operating a machine system comprising a plurality of machines and a machine system comprising a plurality of machines.

### BACKGROUND OF THE INVENTION

Operating a machine system comprising a plurality of machines by at least one operator requires an interaction between the machine system and the operator.

As an example, German patent application DE 10 2009 002 136 A1 discloses a method for displaying a current task list on the graphical user interface of a control computer of a processing machine. Only those tasks running on the control computer are displayed when the task list is called up that are listed in a release list. Only those tasks are listed in said release list which are released as a function of predetermined, dynamically monitored selection criteria.

As another example, Korean patent application KR 2009 0059693 A discloses a user information recognition device for reading user recognition information input from a user. An external storage device is used for storing user information. The user information stored in the external storage device is read, and user recognition information recognized from the user recognition device is compared with the user information stored in the external storage device to determine whether the user has permission to use. When it is determined that the user has the right to use, the user interface configuration information stored in the external storage device is retrieved, and a human-machine-interface function module corresponding to the machine tool model designated for each user is configured according to the user interface configuration information.

However, the interplay between the machine and the operators is still governed by strict rules.

### SUMMARY OF THE INVENTION

It is an object of the present invention to provide a method of operating a machine system comprising a plurality of machines featuring an improved interplay between the machine system and operators. It is another object of the present invention to provide a machine system comprising a plurality of machines that enables an improved interplay between the machine system and operators.

This object is achieved by the subject-matter of the independent claims.

In an aspect of the present invention, a method of operating a machine system comprising a plurality of machines is provided. Said machines may be any kind of production machines and are in particular machine tool devices with numerical control (NC) or programmable logic controller (PLC) control systems.

The machines are connected to a computing system of the machine system. Said computing system may be a central computing system or a decentralized computing system, e.g., a cloud system. The computing system may also a computing unit of one of the machines or a network of computing units of some of the machines. The computing system may control the machines and may receive messages from the machines, such as error messages or alerts.

The machine system further comprises human-machine-interfaces to present machine information and at least one operator detection unit. Said operator detection unit detects a machine operator being in the proximity of a machine and/or walking past a machine. The operator detection units may be allocated to the machines of the machine system but they may also be located between the machines or be attached to the ceiling above the machines.

The operator detection unit collects operator behavior data and sends the collected operator behavior data to the computing system. The computing system selects information to be presented to the machine operator in dependence on the operator behavior data and selects at least one of the human-machine-interfaces to present said information. The selected information may be any information about the machine system that is relevant to the operator, e.g., that keeps the operator informed about the machine system and/or about tasks that have to be performed at the machine system. The selection is based on the operator behavior data such that the machine system is operated most efficiently, e.g., such that the production rate is maximized or that the production cost is minimized. As an example, selection criteria may be the distance from the operator to a machine that needs maintenance such that the machine with the shortest distance to the operator is serviced first. Further, the selection of the human-machine-interface to present said information may be based on the distance of the human-machine-interface from the operator, on a visibility of the human-machine-interface to the operator or on the appropriateness of the human machine-interface to present the information, e.g., a speaker is not appropriate to present a diagram. Based on this selection, the selected human-machine-interfaces present the selected information.

Since information to be presented to the operator and the human-machine-interfaces that present said information are selected based on the operator behavior data, there is a good interplay between the machine system and the operator. Hence, the machine system may select the information to be presented to the operator such that the operator may work more efficiently and thus that the machine system is operated most efficiently.

In an example, the machines are integrated into a middleware operating system of the computing system. That way, the communication between the machines and the computing system is fast and addressing the machines from the computing system is easy.

In an example, the human-machine-interface is a panel adapted to display the selected information. A panel may display both simple information, e.g., a few words and complex information, e.g., charts or graphs. Said panel may be a touch display such that the operator can provide feedback via the panel. Additionally or alternatively, the human-machine interface may be a loudspeaker adapted to play the selected information. Playing information via a loudspeaker has the advantage that the operator is not required to look at a display while receiving the information.

In an example, human-machine-interfaces that are located in areas where no operator has been detected by the operator detection unit are put in standby mode. This saves energy and prolongs the life of the human-machine-interfaces.

In an example, the operator detection unit comprises a proximity sensor, a camera, a wireless communication unit and/or a radio-frequency identification unit. Proximity sensors sense the proximity of an operator and are therefore preferably positioned at or close to a machine such that the proximity of the operator to the machine is detected. Cameras may be positioned at or close to a machine but may also be positioned more centrally, e.g., at the ceiling. In particular, wide-angle cameras may cover a wide area. A wireless communication unit may comprise a wireless communication device carried by or worn by the operator. A position of the operator may then be determined, for example, by the signal strength between the wireless communication device and one or more wireless transceivers. Similarly, a radio-frequency identification unit may comprise a radio-frequency identification tag carried by or worn by the operator and a corresponding radio-frequency identification reader. In particular, in order to detect the machine operator being in the proximity of a machine and/or walking past a machine, input from several parts of the operator detection unit are used, e.g., a proximity sensor to sense that a person is close to the machine and a wireless communication device to identify said person.

In an example, the operator behavior data includes an operator identification, an operator location, an operator velocity, directions of the operator's body movement, information about the current occupation of the operator, operator concentration, i.e., the operator's attentional control, operator focus and/or operator vital signs. Operator identification may, e.g., be performed by an identification of the wireless communication device or the radiofrequency identification tag carried by or worn by the operator. The operator may also be identified by image recognition based on the camera images. The operator location may be determined based on the operator's proximity to proximity sensors, based on the signal strength of wireless communication and/or radio-frequency identification signals or based on the analysis of images showing the operator. The operator velocity may be determined from a time-series of operator locations and the corresponding difference quotients. Directions of the operator's body movement, operator concentration and/or operator focus may be determined based on an analysis of the camera images. The current occupation of the operator may be determined based on an analysis of the camera images or via feedback from the machine that the operator is currently working on. Finally, the vital signs of the operator may be determined, e.g., by an activity tracker worn by the operator.

In an example, the operator behavior data is stored by the computing system, in particular in nonvolatile memory. Operator behavior habits are then determined from the operator behavior data, e.g., by phenomenological models or by artificial intelligence. Phenomenological models may have a predetermined operator path as an input and fit times needed to cover certain parts of the path and times needed to complete tasks at the machine based on the operator behavior data. Artificial intelligence models may also be trained with the available operator behavior data. As a result, the operator behavior habits may include information about times needed for the operator to move from one machine to the next, times needed to perform certain tasks at a machine, points in time when the operator starts and stops working and/or points in time and durations of breaks. The selection of the information to be presented to the operator is also performed in dependence on the determined operator behavior habits, such that the machine system is operated most efficiently. To perform the selection, a prediction of the operator behavior may be made based on the determined operator behavior habits and the effect of information to be presented to the operator may be modeled. Then, the information to be presented to the operator and the human-machine-interface on which it is presented that yield the most efficient operation of the machine system will be chosen. As an example, it may be most efficient to present a service alert to the operator before he leaves for a break such that he can service the machine and the machine can continue operating while the operator takes his break.

In an example, the selected information to be presented to the machine operator is chosen among machine status information, production process information, tasks that have to be performed at machines, tasks that will have to be performed at machines in the future and/or warning messages. Said choice is made, e.g., according to importance of the information, urgency of the information and/or number of pieces of information that the operator can take in at a given time.

In an example, in addition to presenting the selected information with the human-machine interface, the computing system triggers an alert to alert the operator of the selected information, in particular if the selected information is an urgent and/or important task and/or a warning. Said alert is adapted to draw the operator's attention to the respective selected information.

In an example, the alert is visual, acoustic and/or haptic, e.g., by a light signal, an alert sound or a vibration. Said light signal may be a flashing light and the alert sound may be a sound comprising one or several notes. In particular, the alert may be coded, e.g., such that a particular color of the light signal or a particular sequence of notes of the alert sound may correspond to different levels or types of alerts. The haptic alert may be generated by a human-machine-interface carried by or worn by the operator, such as a smartphone or a smartwatch.

In an example, the at least one human-machine-interface selected to present the information is a primary human-machine-interface located at or close to the machine in the proximity of the operator. Said human-machine-interface may be directly attached to the respective machine or may be attached to a stand in front of or next to the machine. The at least one human-machine-interface selected to present the information may also be a secondary, portable human-machine-interface allocated to the operator. Said secondary, portable human-machine-interface may be, e.g., a smartphone, which includes both a panel and a loudspeaker, a smartwatch or a headset. In particular, one of the human-machine interfaces may be a primary human-machine interface and another one of the human machine-interfaces may be a secondary human-machine-interface. As an example, the operator may be alerted by the secondary human-machine-interface and more information regarding the alert is presented on the primary human-machine interface.

In an example, the presentation of the information is adapted in dependence on the particular human-machine-interface it is presented on, the identity of the operator and/or the distance of the operator to the human-machine-interface. For example, on a small display or via a headset, an information may be presented that a particular machine needs servicing, whereas on a large display, the details of the servicing needs may also be displayed. As another example, an experienced operator may be asked to perform a certain, more difficult task, whereas an inexperienced operator may just be asked to call a more experienced operator. As yet another example, if the operator is far away from a machine that needs servicing, a large panel may display a few large letters indicating such servicing need such that the operator can read it from far away. As the operator approaches the machine, the letters may become smaller and more information may be displayed.

In an example, if the information presented to the operator is a task to be performed, the operator performs the task and confirms the completion of the task with the human machine-interface. Depending on the human-machine-interface, e.g., a button next to a panel may be pressed, the touchscreen of a panel may be used or a voice input may be made via the microphone of a headset. Alternatively, the operator may use the human machine-interface to input why the task has not been completed. In the latter case, the computing system may re-schedule the task, e.g., for a different operator.

In another aspect of the present invention, a machine system is provided, comprising a plurality of machines. Said machines may be any kind of production machines and are in particular machine tool devices with numerical control (NC) or programmable logic controller (PLC) control systems.

The machine system further comprises a computing system, wherein the machines are connected to the computing system. Said connection may be a wired and/or a wireless connection.

The machine system further comprises human-machine-interfaces to present machine information and at least one operator detection unit to detect a machine operator being in the proximity of a machine and/or walking past a machine and to collect operator behavior data. Said human-machine-interfaces may be primary human-machine-interfaces allocated to a machine and/or secondary human-machine-interfaces allocated to an operator. The operator detection units may be allocated to the machines of the machine system, be located between the machines and/or be attached to the ceiling above the machines. The machine system is operated according to the description above. Hence, it provides good interplay between the machine system and the operator, promotes an efficient work of the operator and allows the machine system to be operated most efficiently.

It shall be understood that a preferred embodiment of the invention can also be any combination of the dependent claims with the respective independent claim.

These and other aspects of the invention will be apparent from and elucidated with reference to the embodiments described hereinafter.

### BRIEF DESCRIPTION OF THE DRAWINGS

In the following, preferred embodiments of the invention will be described, by way of example only, and with reference to the drawings in which:

FIG. 1 shows a schematic top view of a machine system,

FIG. 2 shows a schematic front view of a machine,

FIG. 3a shows one embodiment of a human-machine-interface and

FIG. 3b shows another embodiment of a human-machine-interface.

### DETAILED DESCRIPTION OF EMBODIMENTS

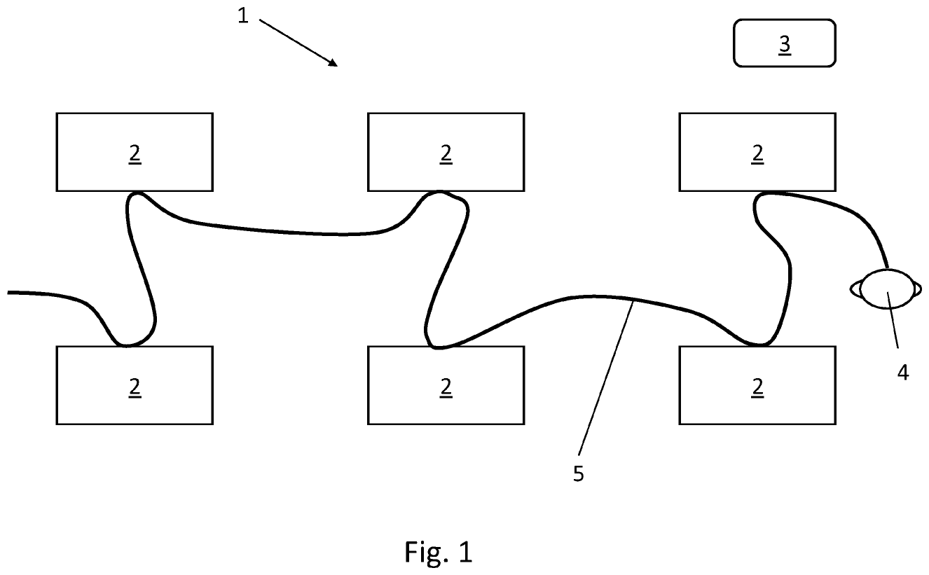

FIG. 1 shows a machine system 1 comprising a plurality of machines 2. The machines 2 may be any kind of production machine and are in particular machine tool devices with numerical control (NC) or programmable logic controller (PLC) control systems.

The machines 2 are connected to a computing system 3 of the machine system 1. The connection may be wired or wireless and is not shown here for reasons of clarity. As an example, the machines 2 may be integrated into a middleware operating system of the computing system 2.

Also shown in FIG. 1 is an operator 4 who performs, e.g., service, maintenance or repair tasks at the machine, and a path that the operator 4 has taken, representing operator behavior data 5. Besides the operator's location, the operator behavior data 5 may include an operator identification, an operator velocity, directions of the operator's body movement, information about the current occupation of the operator, operator concentration, i.e., the operator's attentional control, operator focus and/or operator vital signs.

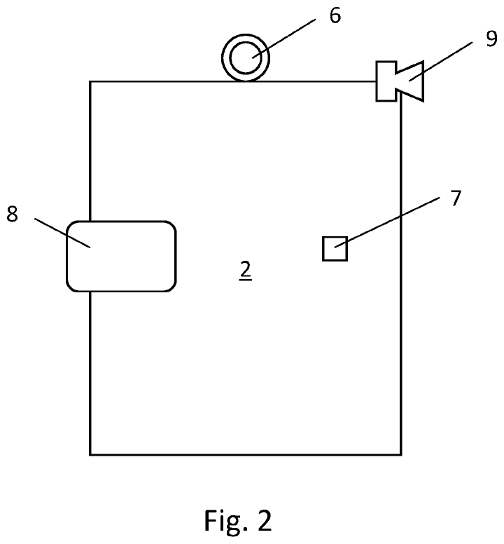

FIG. 2 shows a schematic front view of the machine 2. The machine 2 comprises a camera 6 and a proximity sensor 7, both of which are used to collect operator behavior data 5.

Further operator detection units may include wireless communication units or radiofrequency identification units but are not shown here for reasons of clarity.

The machine 2 further comprises a panel 8 and a loudspeaker 9, which are primary human machine interfaces. Via the panel 8, information may be displayed to the operator 4. If the panel 8 is a touchscreen, the operator 4 may also enter information via the panel 8, e.g. concerning a completed task or a task that could not be completed. Via the loudspeaker 9, acoustic information may be played to the operator 4 and/or the operator 4 may be alerted of an important information, a warning or an error message.

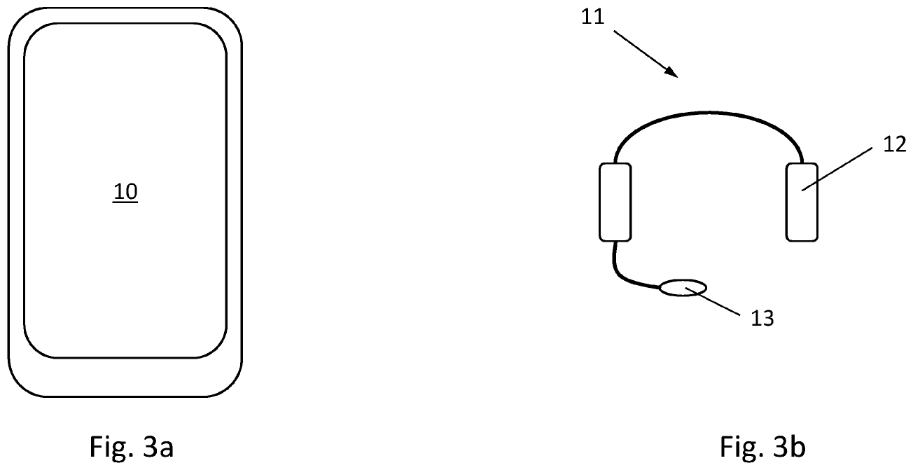

FIGS. 3a and 3b show two examples of secondary, portable human-machine-interfaces which are allocated to the operator (4): FIG. 3a shows a smartphone 10 and FIG. 3b shows a headset 11. Via the smartphone 10, information may be displayed to the operator and the operator 4 may enter responses to certain information. Via the speakers 12 of the headset 11, information may be played to the operator 4 and the operator 4 may reply via the microphone 13. Other examples of secondary, portable human-machine-interfaces include smart glasses and smartwatches.

In an example, the cameras 6, proximity sensors 7 and other operator detection units collect operator behavior data 5 and send it to the computing system 3. The computing system 3 collects the operator behavior data 5, stores it, and determines operator behavior habits based on the operator behavior data 5. Such operator behavior habits may include the time needed for the operator 4 to move from one machine 2 to the next machine 2, the path that the operator 4 follows between the machines 2, the time that the operator 4 spends at each machine 2 and the extra time that the operator 4 needs if there is a specific task to be completed at the machine 2, and/or points in time and durations of breaks that the operator 4 takes, etc.

Based on the operator behavior habits and hence on the operator behavior data 5, the computing system 3 selects information to be presented to the operator 4 and the human machine-interface that presents said information. For example, the computing system 3 receives an alert from one of the machines 2 that maintenance work has to be performed within the next 15 minutes. In the example, the operator 4 happens to be in the proximity of said machine 2. The computing system 3 determines, based on the operator behavior habits, that the operator 4 will not return to the machine 2 for another hour. Therefore, the computing system 3 alerts the operator 4 via the loudspeaker 9 that a task has to be performed at the machine 2 and displays details about the required maintenance work on the panel 8. When the operator 4 has completed the maintenance work, he confirms this by pressing a button on the panel 8.

While the invention has been illustrated and described in detail in the drawings and foregoing description, such illustration and description are to be considered illustrative or exemplary and not restrictive; the invention is not limited to the disclosed embodiments.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality.

Any reference signs in the claims should not be construed as limiting the scope.

### LIST OF REFERENCE SIGNS

1 machine system
2 machine
3 computing system
4 operator
5 operator behavior data
6 camera
7 proximity sensor
8 panel
9 loudspeaker
10 smartphone
11 headset
12 speaker
13 microphone

1. A method of operating a machine system comprising a plurality of machines, in particular machine tool devices with numerical control, NC, or programmable logic controller, PLC, control systems, wherein the plurality of machines are connected to a computing system of the machine system, wherein the machine system comprises human-machine-interfaces to present machine information and wherein the machine system comprises at least one operator detection unit, wherein:
the operator detection unit detects a machine operator being in the proximity of a machine of the plurality of machines and/or walking past the machine and collects operator behavior data,
the operator detection unit sends the collected operator behavior data to the computing system,
the computing system selects information to be presented to the machine operator in dependence on the collected operator behavior data and selects at least one of the human-machine-interfaces to present said information and the selected at least one of the human-machine-interfaces present the selected information.

2. The method according to claim 1, wherein the plurality of machines are integrated into a middleware operating system of the computing system.

3. The method according to claim 1, wherein the selected at least one of the human-machine-interfaces is a panel adapted to display the selected information and/or a loudspeaker adapted to play the selected information.

4. The method according to claim 1, wherein any of the human-machine-interfaces that are located in areas where no operator has been detected by the operator detection unit are put in standby mode.

5. The method according to claim 1, wherein the operator detection unit comprises a proximity sensor, a camera, a wireless communication unit and/or a radio-frequency identification unit.

6. The method according to claim 1, wherein the operator behavior data includes an operator identification, an operator location, an operator velocity, directions of body movement of the operator, information about a current occupation of the operator, operator concentration, operator focus and/or operator vital signs.

7. The method according to claim 1, wherein the operator behavior data is stored by the computing system, operator behavior habits are determined from the operator behavior data and the selection of the information to be presented to the operator is also performed in dependence on the operator behavior habits.

8. The method according to claim 1, wherein the selected information to be presented to the machine operator is chosen among machine status information, production process information, tasks that have to be performed at machines, tasks that will have to be performed at machines in the future and/or warning messages.

9. The method according to claim 1, wherein in addition to the selected at least one of the human-machine-interfaces presenting the selected information, the computing system triggers an alert to alert the operator of the selected information.

10. The method according to claim 9, wherein the alert is visual, acoustic and/or haptic.

11. The method according to claim 1, wherein the at least one of the human-machine-interfaces selected to present the information is a primary human-machine-interface located at or close to the machine in the proximity of the operator and/or a secondary, portable human-machine-interface allocated to the operator.

12. The method according to claim 1, wherein the presentation of the information is adapted in dependence on the particular human-machine-interface it is presented on, the identity of the operator and/or the distance of the operator to the particular human-machine-interface.

13. The method according to claim 1, wherein, when the information presented to the operator is a task to be performed, the operator performs the task and confirms completion of the task with the selected at least one of the human-machine-interfaces or uses the selected at least one of the human-machine-interfaces to input why the task has not been completed.

14. A machine system comprising:
a plurality of machines, in particular machine tool devices with numerical control, NC, or programmable logic controller, PLC, control systems,
a computing system, wherein the machines are connected to the computing system,
human-machine-interfaces to present machine information, and
at least one operator detection unit to detect a machine operator being in the proximity of a machine of the plurality of machines and/or walking past the machine and to collect operator behavior data,
wherein the machine system is operated according to claim 1.
